(19) United States
(12) Patent Application Publication
(10) Pub. No.: US 2020/0344294 A1
(43) Pub. Date: Oct. 29, 2020

(54) INFORMATION PROCESSING DEVICE, INFORMATION PROCESSING SYSTEM, AND COMPUTER PROGRAM PRODUCT

(71) Applicant: FUJITSU CLIENT COMPUTING LIMITED, Kanagawa (JP)

(72) Inventor: Yuichiro Imamura, Kawasaki (JP)

(73) Assignee: FUJITSU CLIENT COMPUTING LIMITED, Kanagawa (JP)

(21) Appl. No.: 16/817,037

(22) Filed: Mar. 12, 2020

(30) Foreign Application Priority Data
Apr. 26, 2019 (JP) 2019-086041

(51) Int. Cl. H04L 29/08

(52) U.S. Cl. CPC H04L 67/1095

(57) ABSTRACT

An information processing device includes one or more processors to function as an acquirer that acquires difference information representing a difference between first data stored in a first storage and second data stored in a second storage; and a setter that sets a data communication method for synchronizing the first data and the second data, according to the difference information acquired by the acquirer.

### CROSS-REFERENCE TO RELATED APPLICATIONS

This application is based upon and claims the benefit of priority from Japanese Patent Application No. 2019-086041, filed Apr. 26, 2019, the entire contents of which are incorporated herein by reference.

### FIELD

Embodiments described herein relate generally to an information processing device, an information processing system, and a computer program product.

### BACKGROUND

Conventionally, an information processing system is known, which synchronizes first data stored in a first storage and second data stored in a second storage.

It is beneficial for such an information processing system to avoid decrease in communication processing speed for synchronization of the first data stored in the first storage and the second data stored in the second storage.

It is thus preferable to provide an information processing device, an information processing system, and a computer program product which can avoid decrease in communication processing speed for synchronization of two items of data.

### SUMMARY

According to one aspect of this disclosure, an information processing device includes one or more processors configured to function as an acquirer that acquires difference information representing a difference between first data stored in a first storage and second data stored in a second storage; and a setter that sets a data communication method for synchronizing the first data and the second data, according to the difference information acquired by the acquirer.

### BRIEF DESCRIPTION OF THE DRAWINGS

FIG. 1 is a block diagram illustrating an exemplary information processing system according to an embodiment;

FIG. 2 is a block diagram illustrating an exemplary configuration of a server according to an embodiment;

FIG. 3 is a block diagram illustrating an exemplary configuration of a terminal device according to an embodiment;

FIG. 4 is a block diagram illustrating an exemplary configuration of an information processing device according to an embodiment;

FIG. 5 is a sequence diagram illustrating an exemplary master determining process executed by the information processing system according to an embodiment;

FIG. 6 is a sequence diagram illustrating another exemplary master determining process executed by the information processing system according to an embodiment;

FIG. 7 is a sequence diagram illustrating still another exemplary master determining process executed by the information processing system of the embodiment;

FIG. 8 is a sequence diagram illustrating exemplary data communication process executed by the information processing system of the embodiment;

FIG. 9 is a flowchart illustrating an exemplary process executed by a difference synchronizer of the information processing system of the embodiment;

FIG. 10 illustrates an exemplary synchronization schedule management file according to an embodiment;

FIG. 11 is a sequence diagram illustrating an exemplary process after a synchronization plan executed by the information processing system of the embodiment;

FIG. 12 is a sequence diagram illustrating an exemplary data deletion process executed by the information processing system of the embodiment;

FIG. 13 is a sequence diagram illustrating another exemplary data deletion process executed by the information processing system of the embodiment;

FIG. 14 is a diagram illustrating an exemplary home screen according to an embodiment;

FIG. 15 is a diagram illustrating an exemplary synchronization control screen according to an embodiment;

FIG. 16 is a diagram illustrating an exemplary display screen depicting synchronization statuses of all information processing terminals according to an embodiment;

FIG. 17 is a diagram illustrating an exemplary display screen displaying a synchronization status of some information processing device of the embodiment;

FIG. 18 is a diagram illustrating an exemplary setting screen for an application cache parameter according to an embodiment;

FIG. 19 is a diagram illustrating an exemplary master setting file according to an embodiment;

FIG. 20 is a diagram illustrating an exemplary information file of an information processing terminal according to an embodiment;

FIG. 21 is a diagram illustrating an exemplary master synchronization control parameter file according to an embodiment;

FIG. 22 is a diagram illustrating an exemplary slave synchronization control parameter file according to an embodiment;

FIG. 23 is a diagram illustrating an exemplary operation status management file of the information processing device of the embodiment;

FIG. 24 is a diagram illustrating an exemplary master synchronization schedule management file according to an embodiment; and

FIG. 25 is a diagram illustrating an exemplary slave synchronization management file less than a child threshold according to an embodiment.

### DETAILED DESCRIPTION

Hereinafter, exemplary embodiments of this disclosure will be described. Elements or configurations of the following embodiments, and operations and effects attained thereby are merely exemplary and are not intended to limit the scope of the present invention.

### Overall Configuration of Information Processing System 1

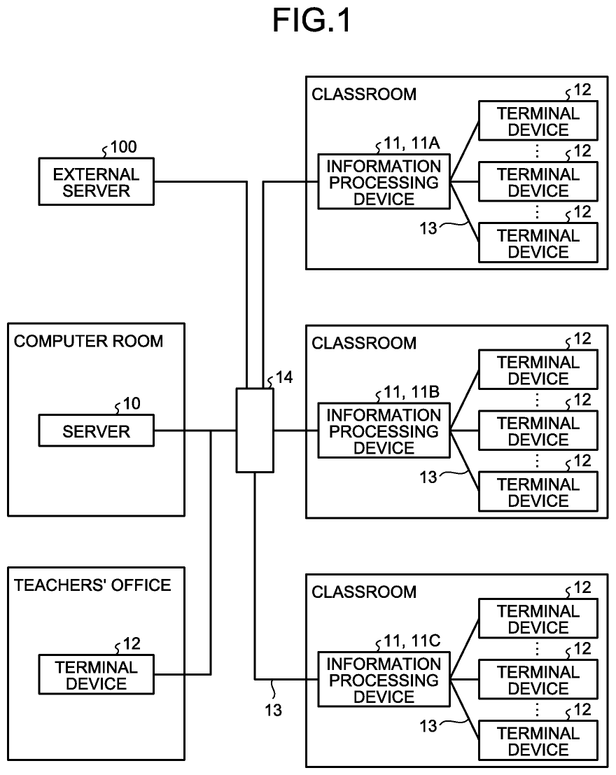

FIG. 1 is a block diagram illustrating an exemplary information processing system 1 according to an embodiment.

The information processing system 1 is, for example, installed in a school to manage data such as textbook data used in classes and student work data. In a school there are typically a computer room, a teachers' office, and a plurality of classrooms, for example. The information processing system 1 may be installed in a place other than the school.

The information processing system 1 includes a server 10 installed in the computer room, a plurality of information processing devices 11, each of which is installed in each of the classrooms, and a plurality of terminal devices 12 installed in the teachers' office and the classrooms. The information processing devices 11 are an information processing device 11A, an information processing device 11B, an information processing device 11C. The server 10, the information processing devices 11, and the terminal devices 12 are communicably connected via a communication network 13. The communication network 13 includes one or both of a wired communication network and a wireless communication network. In addition, the communication network 13 includes a switch 14. The switch 14 represents a layer 3 switch. The information processing system 1 is communicably connected to an external server 100 via the communication network 13. The external server 100 is installed in, for example, the board of education facility.

In the information processing system 1, for example, teaching material data and test answer-sheet data are downloaded from the server 10 to the information processing device 11. The downloaded data is transferred from the information processing device 11 to the terminal devices 12 in the classroom. Data such as answer data including students' answers to test data is uploaded from each terminal device 12 in the classroom to the information processing device 11. The uploaded data is uploaded from the information processing device 11 to the server 10.

In such data communication, the information processing device 11 sets a data communication method for synchronizing two items of data, in accordance with a difference between the two items of data. There are three data communication methods, i.e., a first method of parallel data communications (hereinafter, also referred to as parallel transfer), a second method of sequential data communications (hereinafter, also referred to as serial transfer), and a third method of data communication during a preset period (hereinafter, also referred to as time-shift transfer). In the above data communication, the data stored in the information processing device 11 represents first data, and the data stored in the server 10 represents second data. Data communication setting method will be described in detail later.

### Server 10

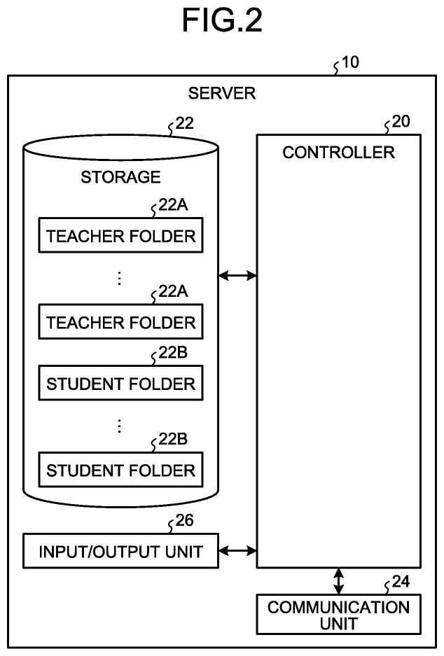

FIG. 2 is a block diagram illustrating an exemplary configuration of the server 10 of the embodiment.

The server 10 includes a controller 20, a storage 22, a communication unit 24, and an input/output unit 26. The controller 20, the storage 22, the communication unit 24, and the input/output unit 26 are connected to be able to exchange data or a signal.

The storage 22 stores various kinds of information. For example, the storage 22 stores a plurality of teacher folders 22A and a plurality of student folders 22B. The teacher folders 22A are provided for individual teachers, and the student folders 22B are provided for individual students. Each of the teacher folders 22A stores teaching material data, test answer-sheet data, for example. Each of the student folders 22B stores student answer data representing students' answers to the test answer-sheet data, for example. In addition, the storage 22 stores various files such as a master setting file, and an operation status management file of an information processing device. For example, the storage 22 serves as a known storage medium such as a hard disk drive (HDD) or a solid state drive (SSD).

The communication unit 24 serves as a communication interface for communicating with other devices including the information processing device 11, the terminal device 12, and the external server 100 via the communication network 13.

The input/output unit 26 functions as an input to receive an operational instruction from a user and a display to display an image. The input represents, for example, a keyboard and a mouse, for example. The display function represents, for example, a liquid crystal display device or an organic electroluminescence (EL) display. The input/output unit 26 may serve as a touch panel display functioning as both the input and the display.

The controller 20 includes a CPU, a ROM, and a RAM. That is, the controller 20 serves as a computer. The CPU reads and executes a program from the ROM, for example. The CPU is configured to be able to execute various computations in parallel. The RAM temporarily stores various kinds of data for use by the CPU to execute programs to implement various computations.

### Terminal Device 12

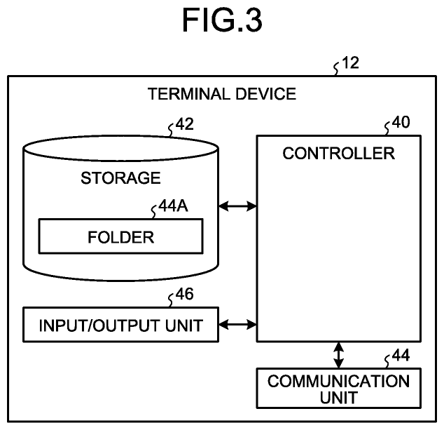

FIG. 3 is a block diagram illustrating an exemplary configuration of the terminal device 12 in the embodiment.

The terminal device 12 includes a controller 40, a storage 42, a communication unit 44, and an input/output unit 46. The controller 40, the storage 42, the communication unit 44, and the input/output unit 46 are connected to be able to exchange data or a signal. The terminal device 12 serves as, for example, a tablet personal computer. The terminal device 12 may be a desktop personal computer, for example.

The storage 42 stores various kinds of information. The storage 42 stores, for example, a folder 44A. The folder 44A contains user information. In the case of the user being a teacher, for example, teaching material data and test answer-sheet data are stored in the folder 44A. In the case of the user being a student, teaching material data, test answer-sheet data, and teaching-material student-answer data. are stored in the folder 44A. The terminal device 12 identifies the user from a user identification number input at the time of login. For example, the storage 42 is a known storage medium such as a hard disk drive (HDD) or a solid state drive (SSD).

The communication unit 44 serves as a communication interface for communicating with other devices including the server 10, the information processing device 11, and the external server 100 via the communication network 13.

The input/output unit 46 serves as an input to receive an operational instruction from the user and a display to display an image. The input/output unit 46 represents, for example, a touch panel display functioning as both the input and the display. For example, the display serves as a liquid crystal display or an organic EL display. The input and the display may be separated. In this case, the input may be a keyboard and a mouse, for example.

The controller 40 includes a CPU, a ROM, and a RAM. That is, the controller 40 serves as a computer. The CPU reads and executes a program from the ROM, for example. In addition, the CPU is configured to be able to execute various computations in parallel. The RAM temporarily stores various data for use by the CPU's executing programs to implement various computations. The controller 40 can identify the user from a user identification number input at the time of login.

### Information Processing Device 11

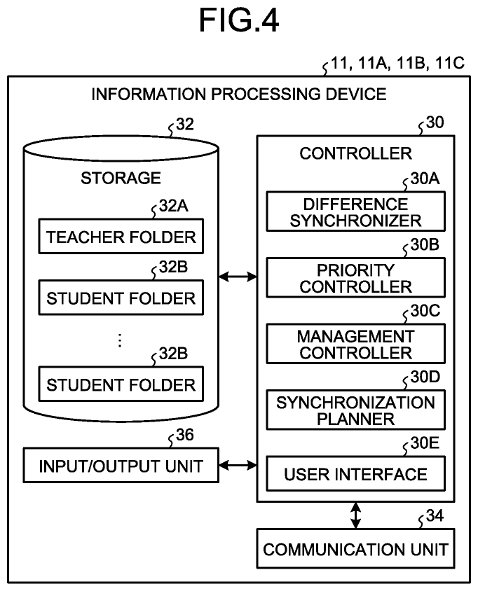

FIG. 4 is a block diagram illustrating an exemplary configuration of the information processing device 11 of the embodiment.

As illustrated in FIG. 4, the information processing device 11 includes a controller 30, a storage 32, a communication unit 34, and an input/output unit 36. The controller 30, the storage 32, the communication unit 34, and the input/output unit 36 are connected to be able to exchange data or a signal.

The storage 32 stores various kinds of information. For example, the storage 32 stores a teacher folder 32A and a plurality of student folders 32B. The student folders 22B are provided for individual students. The teacher folder 32A stores teaching material data and test answer-sheet data, for example. Each of the student folders 32B stores student answer data and else. The storage 22 represents, for example, a known storage medium such as an HDD or an SSD.

The communication unit 34 serves as a communication interface for communicating with other devices including the server 10, the terminal device 12, and the external server 100 via the communication network 13.

The input/output unit 36 functions as an input to receive an operational instruction from the user and a display to display an image. The input represents a keyboard and a mouse, for example. The display represents a liquid crystal display device or an organic EL display, for example. The input/output unit 46 may be a touch panel display functioning as both the input and the display.

The controller 30 includes a CPU or one or more processors, a ROM, and a RAM. That is, the controller 30 serves as a computer. The CPU reads and executes a program from the ROM, for example. The CPU is configured to be able to execute various computations in parallel. The RAM temporarily stores various kinds of data for use by the CPU's executing programs to implement various computations.

The controller 30 includes, as functional elements, a difference synchronizer 30A, a priority controller 30B, a management controller 30C, a synchronization planner 30D, and a user interface (UI) 30E. These functional elements are implemented by the CPU's executing a program stored in the ROM, for example. Part or all of the functional elements may be implemented by dedicated hardware or circuitry.

The difference synchronizer 30A acquires difference information representing a difference between two items of data to be synchronized. The difference information includes an amount of difference between the two items of data. The two items of data to synchronize are data stored in the storage 22 of the server 10 and data stored in the storage 22 of the information processing device 11 including the difference synchronizer 30A. Specifically, for example, in the case of downloading data from the server 10 to the information processing device 11, the two items of data to synchronize are the teacher folder 22A in the storage 22 of the server 10 and the teacher folder 32A corresponding to the teacher folder 22A in the storage 32 of the information processing device 11. In the case of uploading data from the information processing device 11 to the server 10, for example, the two items of data to synchronize are the student folder 32B in the storage 32 of the information processing device 11 and the student folder 22B corresponding to the student folder 32B in the storage 22 of the server 10. The difference synchronizer 30A synchronizes the data stored in the storage 22 of the server 10 with the data stored in the storage 22 of the information processing device 11. The difference synchronizer 30A is an exemplary acquirer.

The priority controller 30B sets a data communication method for synchronizing two items of data, according to the difference information acquired by the difference synchronizer 30A. Specifically, the priority controller 30B calculates an estimated time taken for synchronization, on the basis of information representing a difference between two items of data to synchronize and a current traffic of data communication. The current traffic can be obtained, for example, by transmitting a PING to the server 10. The priority controller 30B sets the data communication method in accordance with the estimated time and a threshold. Specifically, the priority controller 30B sets parallel transfer as the data communication method when the estimated time is less than a given child threshold. The priority controller 30B is an exemplary setter, and the child threshold is an exemplary first threshold.

The management controller 30C sets a data communication method in accordance with the difference between the two items of data and the threshold. Specifically, when the estimated time is equal to or greater than the child threshold and less than a given parent threshold greater than the child threshold, the management controller 30C sets serial transfer as the data communication method. Further, the management controller 30C arbitrates data communication (arbitration control). Specifically, in the serial transfer the management controller 30C determines order of data communications according to priority set to the two items of data. Herein, the data priority is set according to a type of data. The type of data refers to a teaching material, an answer, and a subject, for example. The management controller 30C is an exemplary setter, and the parent threshold is an exemplary second threshold.

The synchronization planner 30D plans or sets a time-shift transfer period. For example, the time-shift transfer period is set in a time slot not affecting classes, such as a break or after school. Specifically, when the estimated time is equal to or greater than the parent threshold, the synchronization planner 30D sets the time-shift transfer as the data communication method.

The user interface 30E provides various kinds of information to the user and receives settings or changes of various set items.

### Master and Slave Determination

In the present embodiment, the information processing system 1 sets the information processing device 11 as a master (hereinafter, also referred to as a master information processing device 11) in which all of the difference synchronizer 30A, the priority controller 30B, the management controller 30C, and the synchronization planner 30D operate. The information processing system 1 sets the information processing device or devices 11 as a slave (hereinafter, also referred to as slave information processing devices 11) in which part of the difference synchronizer 30A, the priority controller 30B, the management controller 30C, and the synchronization planner 30D operates. The master information processing device 11 is one of the information processing devices 11, and the slave information processing devices 11 are the rest of the information processing devices 11.

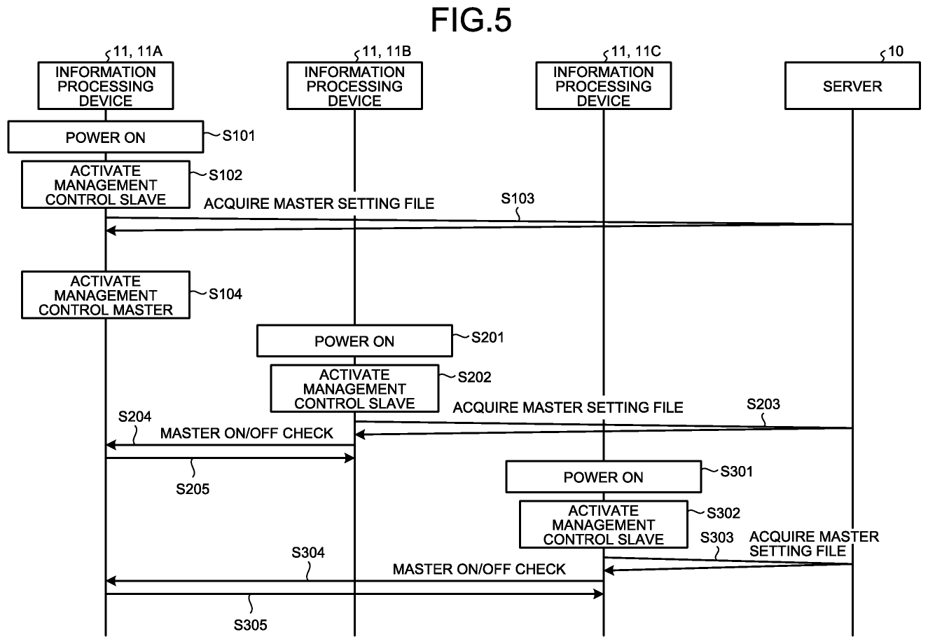

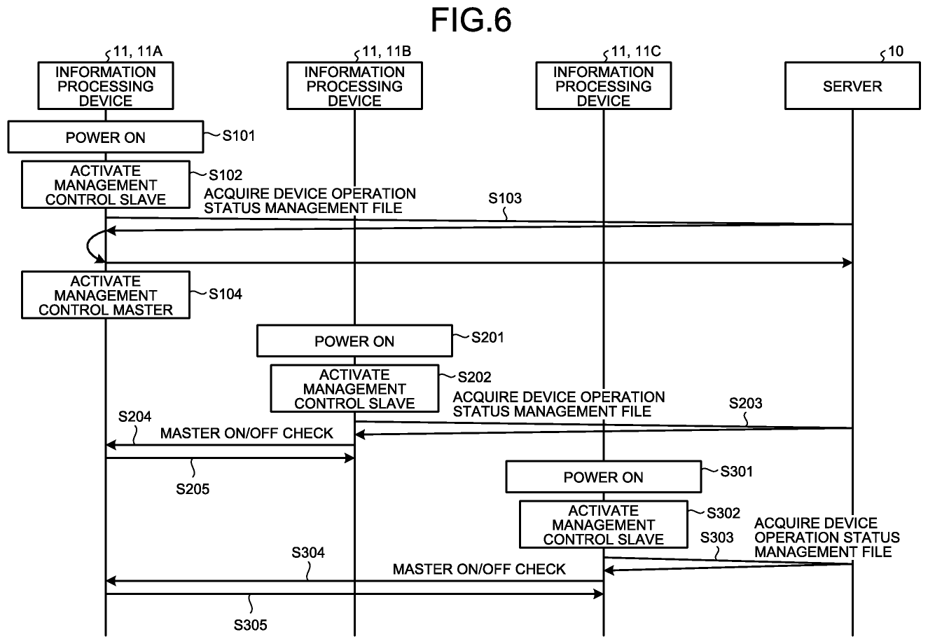

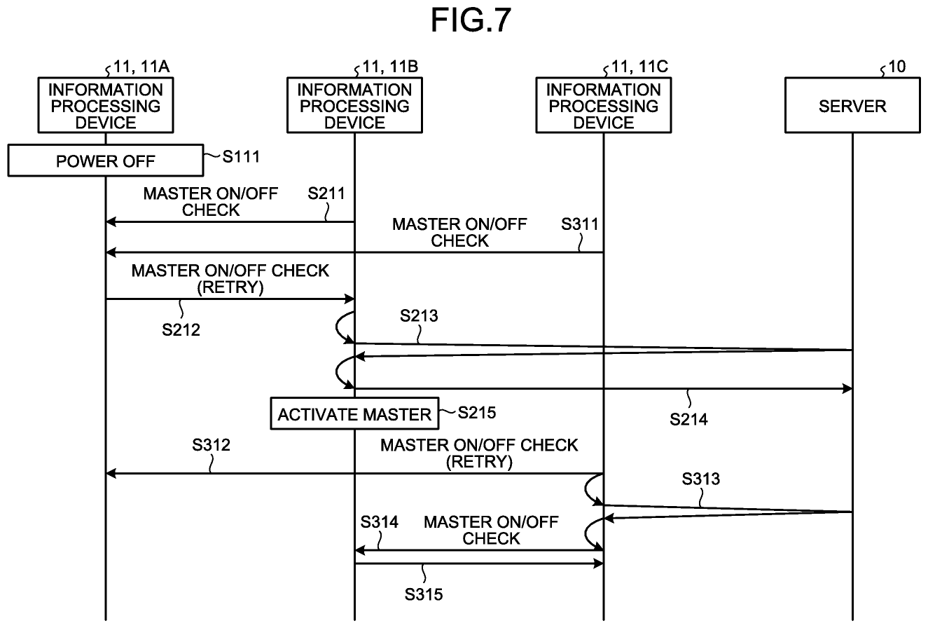

Next, a method of determining the master information processing device 11 will be described. FIG. 5 is a sequence diagram illustrating an exemplary master determining process executed by the information processing system 1 according to the embodiment. FIG. 6 is a sequence diagram illustrating another exemplary master determining process executed by the information processing system 1 according to the embodiment. FIG. 7 is a sequence diagram illustrating still another exemplary master determining process executed by the information processing system 1 according to the embodiment.

There are, for example, two determining methods of the master information processing device 11, that is, a first method of presetting an information processing device to serve as a master, and a second method of determining an initially booted information processing device 11 to be the master among the information processing devices 11.

First, the first method will be described with reference to FIG. 5. FIG. 5 illustrates an example of setting the information processing device 11A as the master in the master setting file stored in the storage 22 of the server 10. In the example of FIG. 5, the information processing device 11A, the information processing device 11B, and the information processing device 11C are powered on in this order, that is, the information processing device 11A boots up first among the information processing devices 11.

After power-on (S101), that is, startup, the information processing device 11A activates a slave function (hereinafter, also referred to as a management control slave) of the management controller 30C (S102). The management controller 30C acquires a master setting file from the server 10 (S103). After determining that the information processing device 11A is set as a master in the master setting file, the information processing device 11A activates a master function (hereinafter, also referred to as a management control master) of the management controller 30C (S104). Thus, the information processing device 11A serves as the master.

Meanwhile, after power-on (S201 and S301), that is, startup, the information processing devices 11B and 11C activate the slave function (management control slave) of the management controller 30C (S202 and S302). The management controller 30C acquires the master setting file from the server (S203 and S303). After determining that the information processing device 11A is set as a master in the master setting file, the information processing devices 11B and 11C check if the information processing device 11A (S204 and S304) is running. The management controller 30C recognizes that the master information processing device 11A is running, by receiving a response from the information processing device 11A (S205 and S305).

Next, the second method will be described with reference to FIG. 6. As with the example of FIG. 5, FIG. 6 illustrates an example that the information processing device 11A, the information processing device 11B, and the information processing device 11C are powered on in this order, that is, the information processing device 11A boots up first among the information processing devices 11.

The second method is different from the first method in S103, S203, and S303 that each of the information processing devices 11A and 11B acquires a device operation status management file from the server 10 instead of the master setting file. The device operation status management file contains operation statuses of the respective information processing devices 11. At the time when the information processing device 11A acquires the device operation status management file, the information processing devices 11B and 11C are running, and thus the information processing device 11A activates the management control master. The information processing device 11A writes information about the information processing device 11A being the master to a given area of the device operation status management file. That is, the information processing device 11A serves as the master.

Next, a description will be given of a master changing process upon power-off of the information processing device 11A in FIG. 6, with reference to FIG. 7. After power-off of the master information processing device 11A (S111), the information processing device 11B checks if the master information processing device 11A is running (master on/off check in S211), and receives no response from the information processing device 11A. The information processing device 11B re-checks (retry) if the master information processing device 11A is running (S212). In response to receipt of no response, the information processing device 11B acquires the device operation status management file from the server 10 (S213). The information processing device 11B locks writing from another device to the device operation status management file of the server 10. The information processing device 11B writes information about the information processing device 11B being the master to the device operation status management file of the server 10 (S214). Thus, the information processing device 11B serves as the master.

In the example of FIG. 6, after the power-off of the information processing device 11A, the information processing device 11C checks if the master information processing device is running (master on/off check in S311) and retries checking (S312). In this case, after the retry (S312), the information processing device 11C acquires the device operation status management file from the server 10 (S313), and checks if the information processing device 11B is running (master on/off check in S314). By receiving a response from the information processing device 11B (S315), the information processing device 11C recognizes that the master information processing device 11B is running.

### Data Communication Process

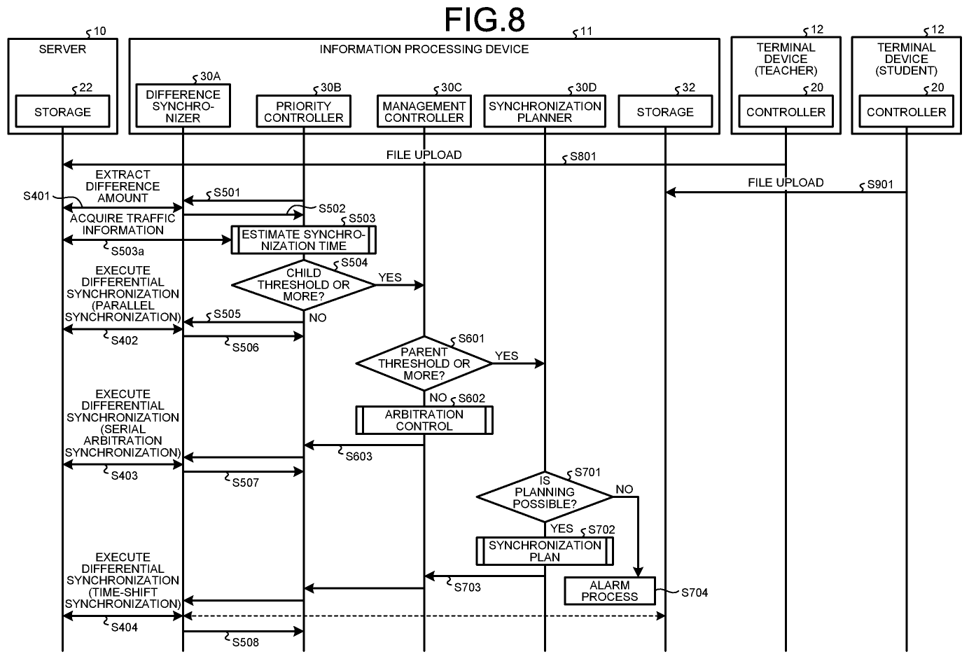

Next, a description will be given of a data communication process executed by the information processing system 1 after determination of the master. FIG. 8 is a sequence diagram illustrating an exemplary data communication process executed by the information processing system 1 of the embodiment.

FIG. 8 illustrates an exemplary process performed by the master information processing device 11 that the teacher terminal device 12 uploads data or a file to the server 10 (S801) or the student terminal device 12 uploads data or a file to the information processing device 11 (S901). In this case, a difference occurs between the data stored in the storage 32 of the master information processing device 11 and the data stored in the storage 32 of the server 10.

The priority controller 30B performs a difference check (S501 and S502). Specifically, the priority controller 30B instructs the difference synchronizer 30A to find the amount of difference between the two items of data (S501). In response to the instruction from the priority controller 30B, the difference synchronizer 30A acquires the amount of difference between the two items of data (S401), and transmits it to the priority controller 30B.

After receiving the amount of difference (S502), the priority controller 30B acquires traffic information through communication with the server 10 (S503a), and estimates a time taken for synchronization of the two items of data from the amount of difference and the traffic information (S503). When the estimated time is neither equal to nor greater than the child threshold (No in S504), the priority controller 30B instructs the difference synchronizer 30A to execute differential synchronization in parallel (S505). Thus, the difference synchronizer 30A executes parallel differential synchronization (S402). After completion of the differential synchronization, the difference synchronizer 30A transmits completion information representing completion of the synchronization to the priority controller 30B, and the priority controller 30B receives the completion information (S506).

When the estimated time is equal to or greater than the child threshold (Yes in S504), the management controller 30C determines whether the estimated time is equal to or greater than the parent threshold (S601). After determining that the estimated time is not equal to or greater than the parent threshold (No in S601), the management controller 30C performs arbitration control (S602). That is, the management controller 30C determines the order of priority for a plurality of data communications. Then, the management controller 30C instructs the difference synchronizer 30A via the priority controller 30B to execute serial synchronization in order of priority (S603). Thus, the difference synchronizer 30A executes serial differential synchronization (S403). After completion of the differential synchronization, the difference synchronizer 30A transmits completion information representing completion of the synchronization to the priority controller 30B, and the priority controller 30B receives the completion information (S507).

When the estimated time is equal to or greater than the parent threshold (Yes in S601), the synchronization planner 30D determines whether to be able to make a synchronization plan (S701). After determining to be able to make a synchronization plan (Yes in S701), the synchronization planner 30D makes a synchronization plan (S702). The synchronization planner 30D instructs the difference synchronizer 30A via the priority controller 30B and the management controller 30C to execute time-shift differential synchronization, following the synchronization plan (S703). Thereby, the difference synchronizer 30A executes time-shift differential synchronization (S404). After completion of the differential synchronization, the difference synchronizer 30A transmits completion information representing completion of the synchronization to the priority controller 30B, and the priority controller 30B receives the completion information (S508).

Meanwhile, after determining to be unable to make a synchronization plan (No in S701), the synchronization planner 30D executes an alarm process (S704).

In the example of FIG. 8 a difference occurs between the data stored in the storage 32 of the master information processing device 11A and the data stored in the storage 32 of the server 10. However, the present embodiment is not limited to such an example. The same process is applicable to a difference occurring between the data stored in the storages 32 of the slave information processing devices 11B and 11C and the data stored in the storage 32 of the server 10. In this case, however, the slave information processing devices 11B and 11C execute the processing in S401 to S404 and S501 to S508 while the master information processing device 11A executes the processing in S601 to S603 and S701 to S704.

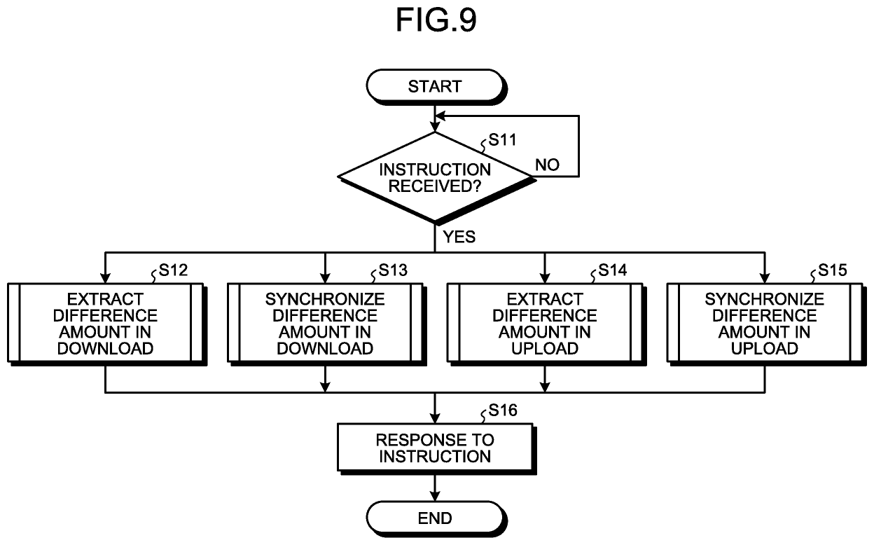

FIG. 9 is a flowchart illustrating an exemplary process executed by the difference synchronizer 30A of the information processing system 1 of the embodiment. The difference synchronizer 30A can execute a plurality of operations in parallel in FIG. 8. Specifically, as illustrated in FIG. 9, the difference synchronizer 30A waits for an instruction from the priority controller 30B (No in S11). After receiving an instruction from the priority controller 30B (Yes in S11), the difference synchronizer 30A executes operations indicated by the instruction in parallel (S12, S13, S14, and S15). For example, the priority controller 30B extracts an amount of difference in certain downloaded data in S12, executes differential synchronization to the certain downloaded data in S13, extracts an amount of difference in certain uploaded data in S14, and executes differential synchronization to the certain uploaded data in S15. The difference synchronizer 30A then transmits, to the priority controller 30B, a response that it has completed the instruction (S16).

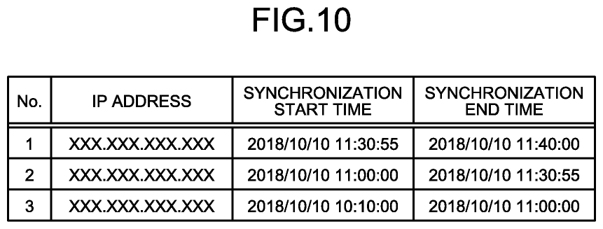

FIG. 10 is a diagram illustrating an exemplary synchronization schedule management file according to an embodiment. In S702 of FIG. 8, details of the synchronization plan (synchronization start time and synchronization end time) are stored in the synchronization schedule management file. The synchronization schedule management file is stored in the server 10, for example.

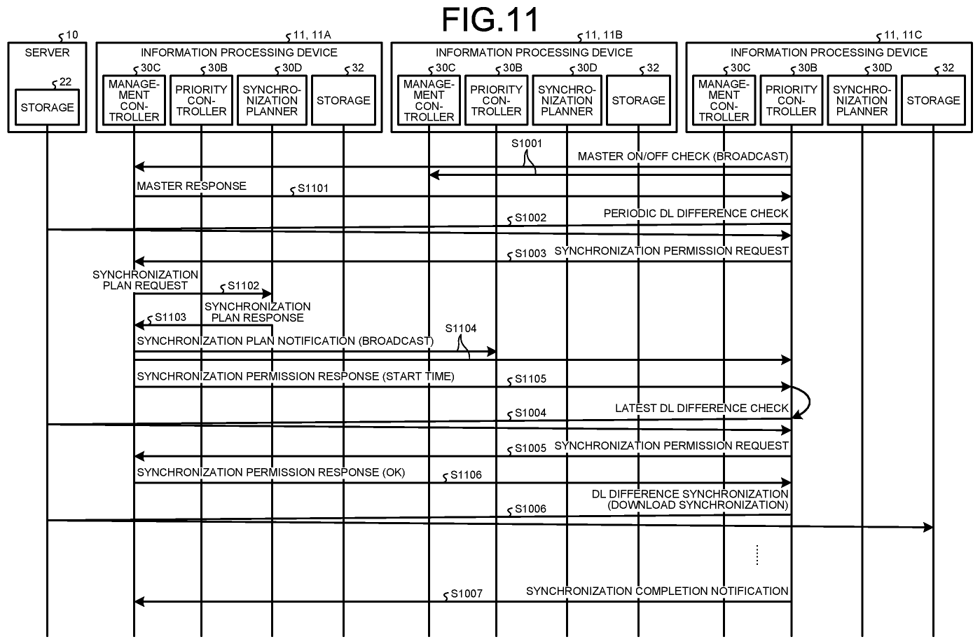

FIG. 11 is a sequence diagram illustrating an exemplary process, after planning the synchronization to be executed by the information processing system 1 of the embodiment.

The following describes an example of changing or adding data (content) to synchronize after planning the synchronization, with reference to FIG. 11. FIG. 11 illustrates synchronization of data to be downloaded, by way of example.

The priority controller 30B of the information processing device 11 (the information processing device 11C in FIG. 11), which changes or adds data after planning the synchronization, checks through broadcast transmission if the master information processing device 11A is running (master on/off check in S1001). Then, the management controller 30C of the master information processing device 11A responds thereto (master response in S1101).

The priority controller 30B of the information processing device 11C periodically checks difference in downloaded data (periodic DL difference check) (S1002). After finding a difference between two items of data, the priority controller 30B calculates an estimated synchronization time, and transmits a synchronization permission request to the management controller 30C of the master information processing device 11A when the estimated time is equal to or greater than the child threshold (S1003). The synchronization permission request includes the estimated time.

The management controller 30C of the master information processing device 11A requests the synchronization planner 30D of the information processing device 11A to issue a synchronization plan (S1102). In response to the request, the synchronization planner 30D makes a synchronization plan. Specifically, the synchronization planner 30D allocates the requested synchronization to a time slot to which the estimated time is allocable. Then, the synchronization planner 30D transmits a synchronization plan including the planned synchronization to the management controller 30C as a response (S1103). The management controller 30C broadcasts the received synchronization plan to each information processing device 11 (S1104). Then, the management controller 30C transmits a synchronization permission notice including synchronization start time to the priority controller 30B of the information processing device 11C as a synchronization permission response (S1105).

After receiving the synchronization permission notice, the priority controller 30B of the information processing device 11C sets the end time of a timer to synchronization start time and operates the timer. When the timer ends counting, the priority controller 30B executes a latest difference check (latest DL difference check) (S1004). Then, the priority controller 30B transmits the synchronization permission request to the management controller 30C of the master information processing device 11A again (S1005).

With no slave information processing devices 11 executing synchronization, the management controller 30C of the information processing device 11A determines whether the synchronization plan coincides with the content of the synchronization permission request. After determining that the synchronization plan coincides with the content, the management controller 30C transmits a synchronization permission notice including information indicating permission of synchronization (for example, “OK”) to the management controller 30C of the master information processing device 11A as a synchronization permission response (S1106). After determining that the content of the synchronization permission request does not coincide with the synchronization plan, for example, when the amount of data is significantly larger than the planned amount, the management controller 30C of the information processing device 11A can instruct the synchronization planner 30D to change the synchronization plan. In this case, a synchronization plan may be shifted to a time slot such as after school, for example.

In response to receipt of the synchronization permission notice, the priority controller 30B of the information processing device 11C synchronizes downloaded data (DL differential synchronization) (S1006), and transmits a synchronization completion notice to the information processing device 11A after completion of the synchronization (S107).

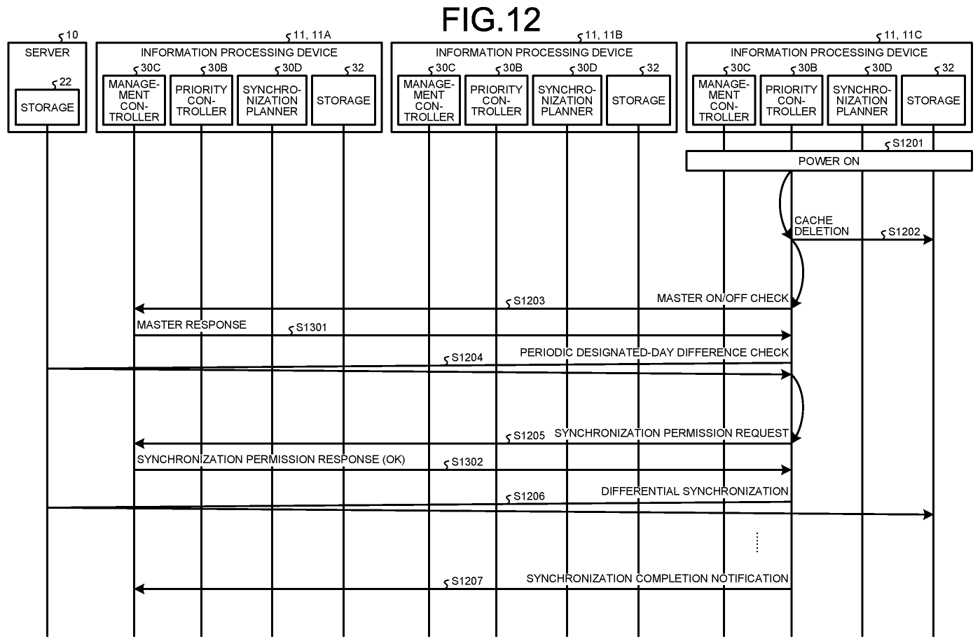

FIG. 12 is a sequence diagram illustrating an exemplary data deletion process performed by the information processing system 1 of the embodiment.

The following describes a deletion process of data stored in the storage 32 of the information processing device 11. As illustrated in FIG. 12, for example, after power-on, the information processing device 11C deletes cache to delete the data from the storage 32 on the basis of the information stored in the synchronization control parameter file of the information processing device 11C (S1202). FIG. 12 illustrates an example that a data holding period is set to one day in the synchronization control parameter file, and it is a different date from the previous last operation time of the information processing device 11.

Next, the priority controller 30B of the information processing device 11C checks if the master information processing device 11A is operating (S1203). The master information processing device 11A transmits a response representing that the master is in operation (S1301). Subsequently, the priority controller 30B of the information processing device 11C performs a difference check for a designated period (S1204). In this periodic difference check, the priority controller 30B subjects data updated within a designated number of previous days to the difference check. This can reduce the amount of data to be synchronized. After finding the difference between the two items of data, the priority controller 30B calculates estimated synchronization time, and when the estimated time is equal to or longer than the child threshold, the priority controller 30B transmits a synchronization permission request to the management controller 30C of the master information processing device 11A (S1205). The synchronization permission request includes the estimated time.

The management controller 30C of the master information processing device 11A issues a synchronization permission response, for example, when the estimated time is less than the parent threshold, (S1206).

After receiving the synchronization permission notice, the priority controller 30B of the information processing device 11C executes differential synchronization (S1206), and transmits a synchronization completion notice to the information processing device 11A upon completion of the synchronization (S1207).

Thus, in the example of FIG. 12, the data is automatically deleted from the storage 32.

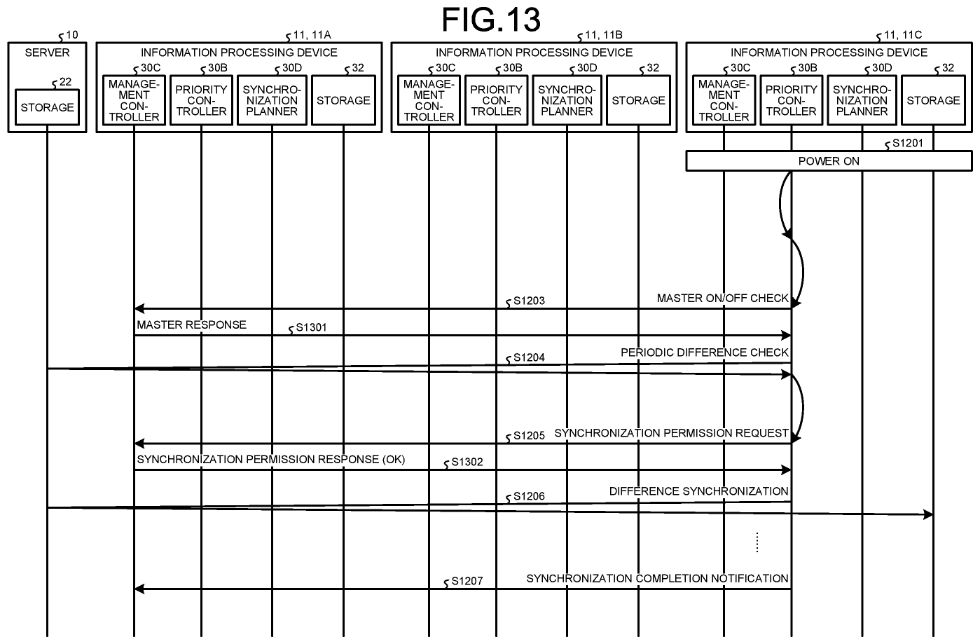

FIG. 13 is a sequence diagram illustrating another exemplary data deletion process executed by the information processing system 1 of the embodiment.

The following describes another exemplary deletion process of the data stored in the storage 32 of the information processing device 11, mainly about a difference from the example of FIG. 12, with reference to FIG. 13. FIG. 13 illustrates an example that the data holding period is set to infinite in the synchronization control parameter file. In this case, the information processing device 11A refrains from executing the processing in S1202 of FIG. 12. In addition, in S1204 the information processing device 11A performs a periodic difference check. In this example, data is not automatically deleted from the storage 32.

### UI Function

Next, a user interface (UI) function of the server 10 will be described.

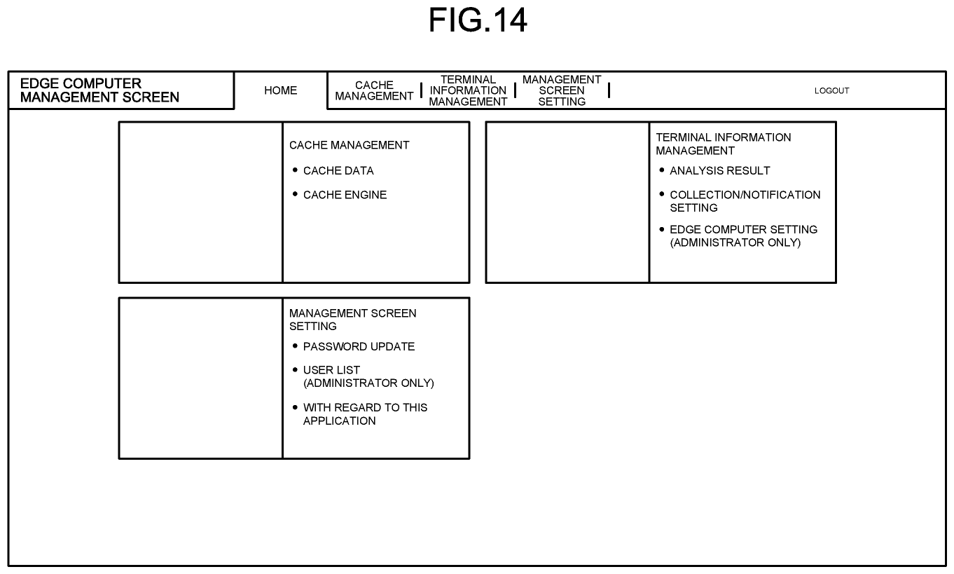

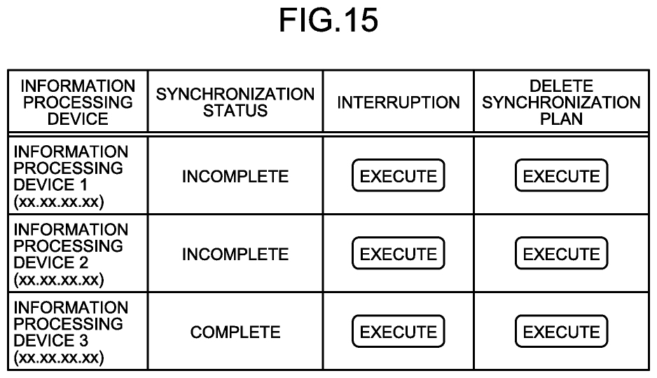

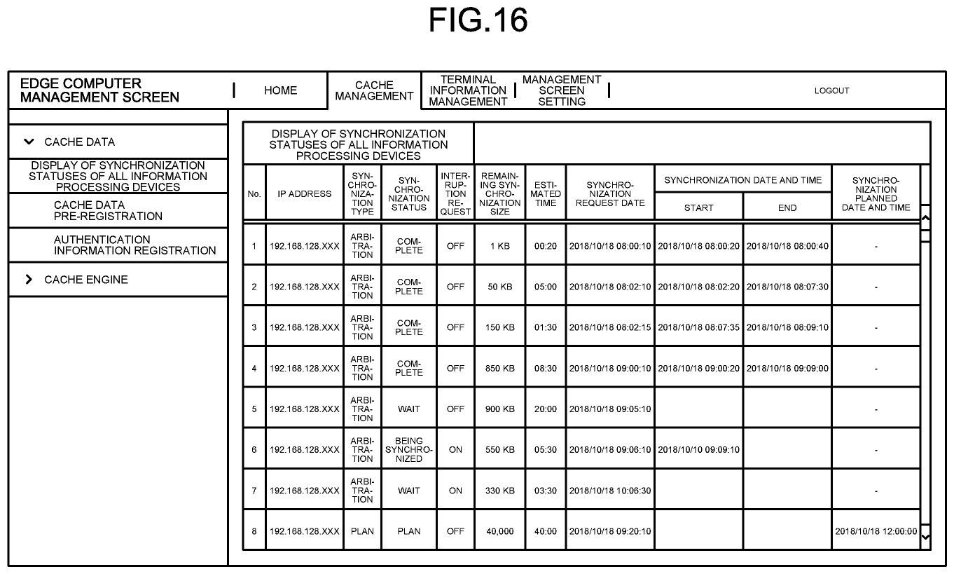

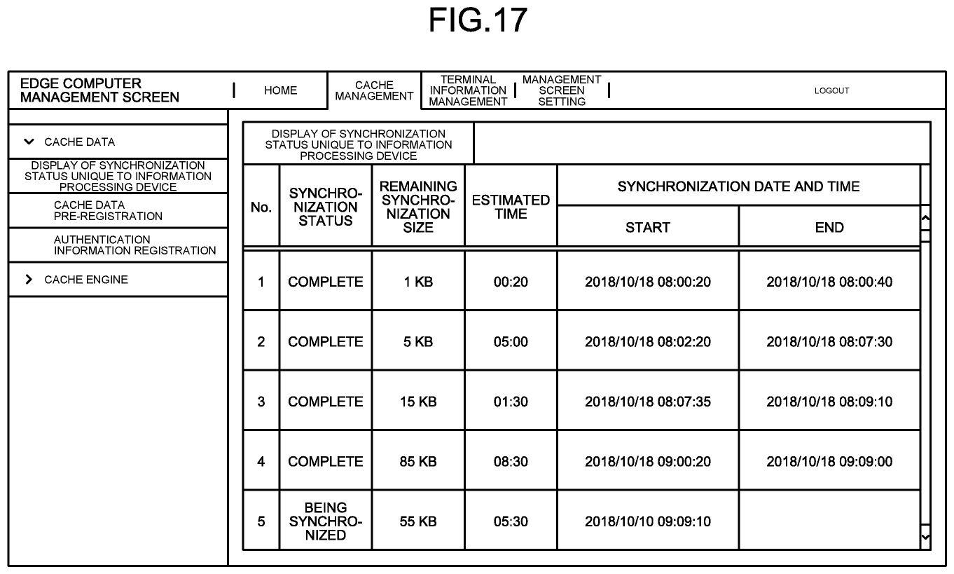

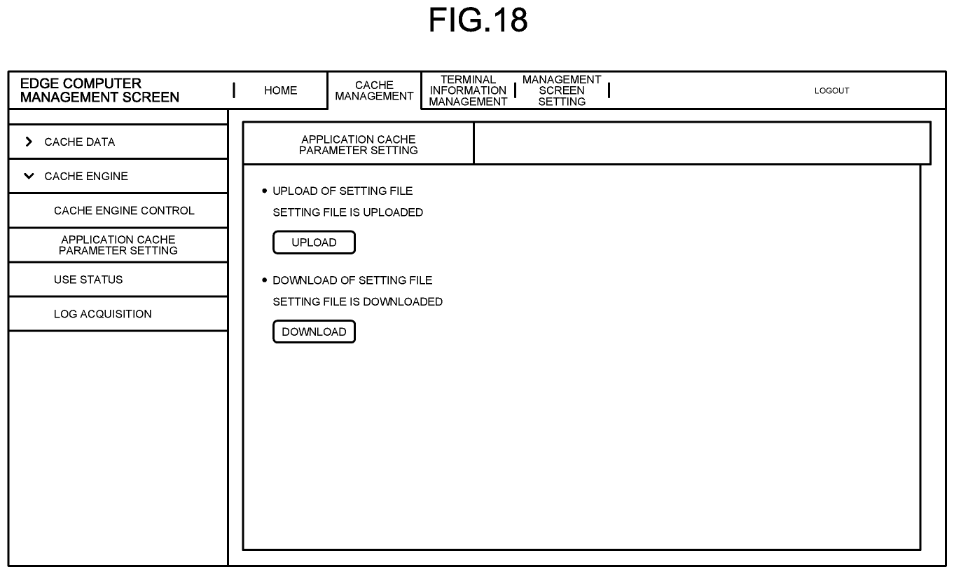

FIG. 14 is a diagram illustrating an exemplary home screen according to an embodiment. FIG. 15 is a diagram illustrating an exemplary synchronization control screen according to an embodiment. FIG. 16 is a diagram illustrating an exemplary display screen displaying synchronization statuses of all the information processing terminals in the embodiment. FIG. 17 is a diagram illustrating an exemplary display screen displaying a synchronization status of the information processing device 11 in the embodiment. FIG. 18 is a diagram illustrating an exemplary application cache parameter setting screen according to an embodiment.

Any of the server 10, the information processing device 11, and the terminal device 12 can access the respective screens above. The user can check, set, or change various kinds of information on the screens.

### Various Files

The following will describe the files described in the above processing.

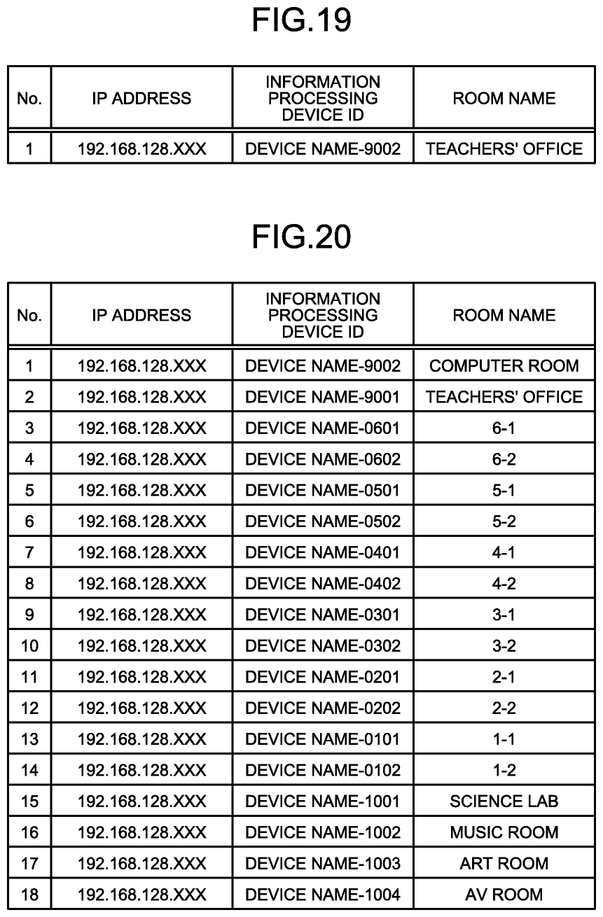

FIG. 19 is a diagram illustrating an example of the master setting file according to an embodiment. As illustrated in FIG. 19, the master setting file contains information for specifying the information processing device 11 to serve as the master.

FIG. 20 is a diagram illustrating an exemplary device information file according to an embodiment. As illustrated in FIG. 20, the device information file contains identification information of each information processing device 11 and else.

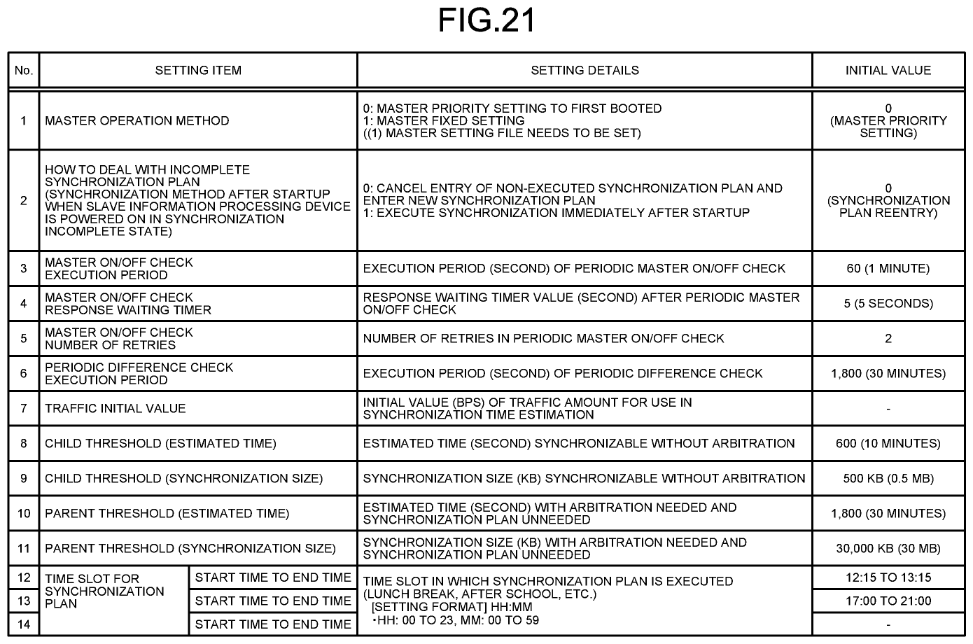

FIG. 21 is a diagram illustrating an exemplary master synchronization control parameter file according to an embodiment. As illustrated in FIG. 21, the master synchronization control parameter file contains various setting items regarding master synchronization control.

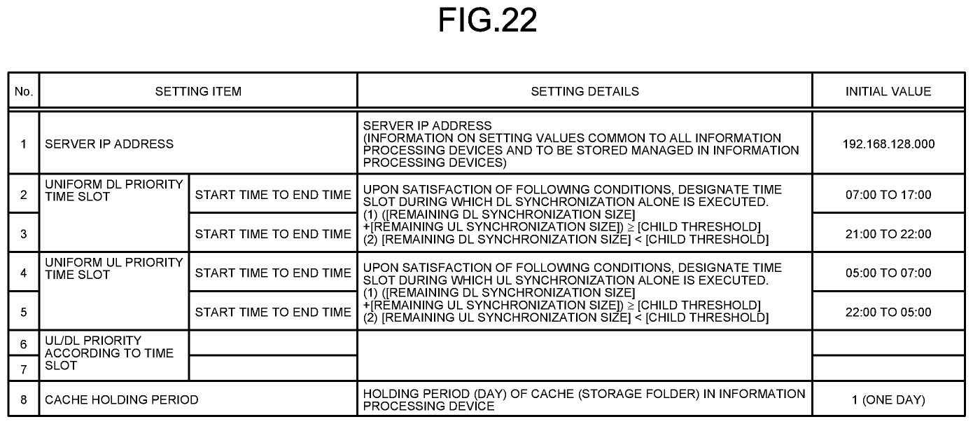

FIG. 22 is a diagram illustrating an exemplary slave synchronization control parameter file according to an embodiment. As illustrated in FIG. 22, the slave synchronization control parameter file contains setting items regarding slave synchronization control.

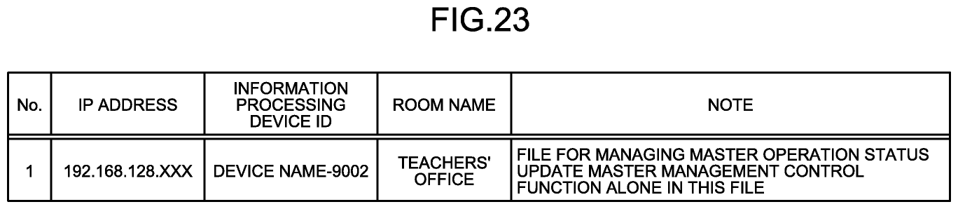

FIG. 23 is a diagram illustrating an exemplary device operation status management file according to an embodiment. The device operation status management file illustrated in FIG. 23 is for managing the master information processing device 11.

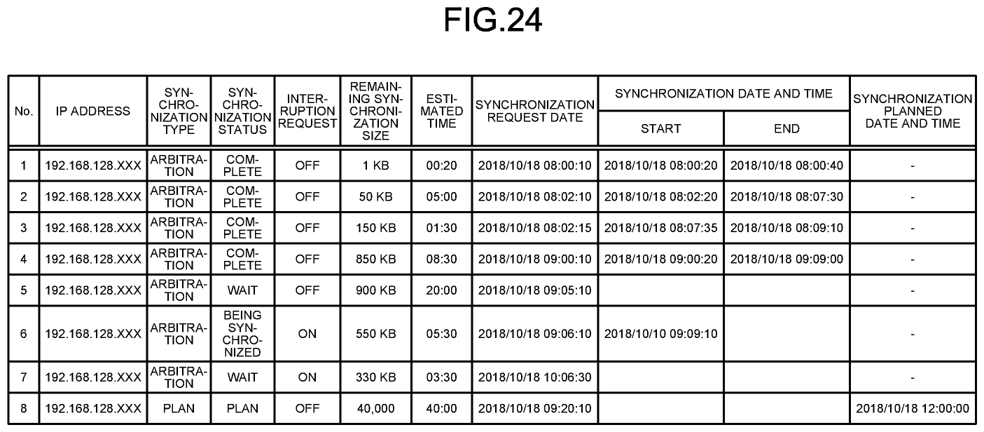

FIG. 24 is a diagram illustrating an exemplary master synchronization schedule management file according to an embodiment. As illustrated in FIG. 24, the synchronization schedule management file contains a synchronization schedule to be managed by the master information processing device 11, that is, a synchronization plan.

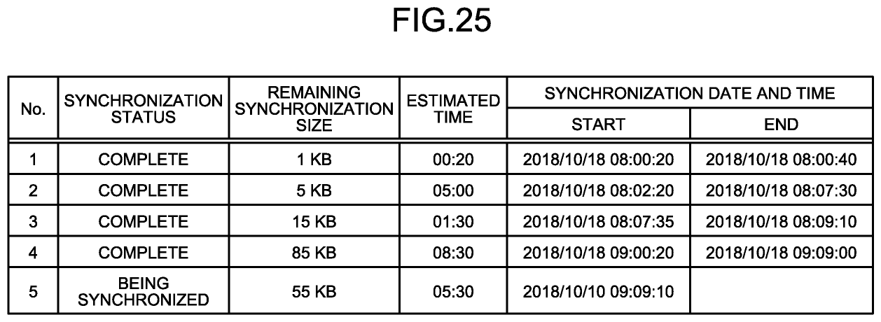

FIG. 25 is a diagram illustrating an exemplary slave synchronization management file less than the child threshold according to an embodiment. As illustrated in FIG. 25, the slave synchronization management file contains information on synchronization of data less than the child threshold in the slave information processing device 11.

As described above, in the present embodiment, for example, the information processing device 11 includes the difference synchronizer 30A (acquirer) that acquires difference information representing a difference between first data (the teacher folder 32A or the student folder 32B) stored in the storage 32 (first storage) of the information processing device 11 and second data (the teacher folder 22A or the student folder 22B) stored in the storage 22 (second storage) of the server 10; and a setter (the priority controller 30B, the management controller 30C, and the synchronization planner 30D) that sets the data communication method for synchronizing the first data and the second data, according to the difference information acquired by the difference synchronizer 30A. That is, the information processing device 11 of the present embodiment can avoid decrease in the communication processing speed for synchronizing two items of data.

In addition, in the present embodiment, for example, the difference information includes an amount of difference between the first data and the second data, and the setter (the priority controller 30B, the management controller 30C, and the synchronization planner 30D) sets the data communication method on the basis of the threshold and the estimated time taken for data synchronization according to the amount of difference.

Further, in the present embodiment, for example, the setter (the priority controller 30B, the management controller 30C, and the synchronization planner 30D) sets, as the data communication method, a first method (parallel synchronization) for performing data communications in parallel when the estimated time is less than the first threshold (child threshold), and sets, as the data communication method, a second method (serial transfer) for performing data communications in order when the estimated time is greater than or equal to the first threshold. Thus, the data communication method can be set depending on the amount of the estimated time.

In addition, in the present embodiment, for example, the setter (the priority controller 30B, the management controller 30C, and the synchronization planner 30D) sets the second method as the data communication method when the estimated time is greater than or equal to the first threshold and less than the second threshold (parent threshold) larger than the first threshold, and sets, as the data communication method, a third method (time-shift synchronization) for performing data communication for a preset period when the estimated time is greater than or equal to the second threshold. Thus, one of the three data communication methods is set depending on the amount of the estimated time.

In addition, in the present embodiment, for example, the setter (the priority controller 30B, the management controller 30C, and the synchronization planner 30D) determines the order of data communications based on the priority set to the first data and the second data in the second method. Thus, the higher priority data is given, the more preferentially the data undergoes data communication.

In addition, in the present embodiment, among the information processing devices 11, the setter of one information processing device 11 sets the second method as the data communication method when the estimated time is greater than or equal to the first threshold, for example. The rest of the information processing devices 11 transmit difference information to the one information processing device 11. Thus, it is possible to reduce a load on the information processing devices other than the one information processing device.

In addition, in the present embodiment, for example, the one information processing device 11 is set in advance. This can relatively simplify the processing.

In addition, in the present embodiment, the initially booted information processing device 11, among the information processing devices, serves as the one information processing device 11, for example. That is, as long as any of the information processing devices 11 is booted, the one information processing device 11 is set. This makes it possible to determine the data communication method without waiting for the other information processing devices 11 to boot.

In addition, in the present embodiment, for example, the information processing devices 11 each include the storage 32 and the controller 30 that deletes the first data from the storage 32 at specified timing. This can avoid old data from remaining in the storage 32.

A program for executing the above-described processing by the server 10, the information processing device 11, and the terminal device 12 is stored and provided as a computer program product in an installable or executable file format on a computer-readable recording medium such as a CD-ROM, a CD-R, a memory card, a digital versatile disk (DVD), and a flexible disk (FD). Alternatively, the program for executing the above-described processing by the server 10, the information processing device 11, and the terminal device 12 may be stored on a computer connected to a network such as the Internet and provided by being downloaded via the network. The program for executing the above-described processing by the server 10, the information processing device 11, and the terminal device 12 may be provided or distributed via a network such as the Internet.

According to one aspect of this disclosure, it is possible to provide an information processing device, an information processing system, and a computer program product which can avoid decrease in communication processing speed for synchronization of two items of data.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing device comprising
one or more processors that functions as:
an acquirer that acquires difference information representing a difference between first data stored in a first storage and second data stored in a second storage; and
a setter that sets a data communication method for synchronizing the first data and the second data, according to the difference information acquired by the acquirer.

2. The information processing device according to claim 1, wherein
the difference information includes an amount of difference between the first data and the second data, and
the setter sets the data communication method on the basis of a threshold and an estimated time taken for synchronizing the first data and the second data according to the amount of difference.

3. The information processing device according to claim 2, wherein
the setter sets, as the data communication method,
a first method for performing data communications in parallel when the estimated time is less than a first threshold, and
a second method for performing the data communications in order when the estimated time is greater than or equal to the first threshold.

4. The information processing device according to claim 3, wherein
the setter sets, as the data communication method,
the second method when the estimated time is greater than or equal to a first threshold and less than a second threshold larger than the first threshold, and
a third method for performing the data communications in a preset period when the estimated time is greater than or equal to the second threshold.

5. The information processing device according to claim 3, wherein
in the second method, the setter determines order of the data communications in accordance with priority set to the first data and the second data.

6. An information processing system comprising:
a plurality of information processing devices according to claim 1; and
a server that is communicable with the information processing devices, wherein
the information processing devices each include the first storage, and
the server includes the second storage.

7. An information processing system, comprising
a plurality of information processing devices according to claim 3, and
the setter of one of the information processing devices sets the second method as the data communication method when the estimated time is greater than or equal to the first threshold, and
the rest of the information processing devices transmit the difference information to the one information processing device.

8. The information processing system according to claim 7, wherein
the one information processing device is set in advance.

9. The information processing system according to claim 7, wherein
the one information processing device is one initially booted among the information processing devices.

10. The information processing system according to claim 6, wherein
the information processing devices delete the first data from the corresponding first storages at specified timing.

11. A non-transitory computer readable medium comprising a computer program product including programmed instructions, wherein the instructions, when executed by a computer, cause the computer to perform:
acquiring difference information representing a difference between first data stored in a first storage and second data stored in a second storage; and
setting a data communication method for synchronizing the first data and the second data, according to the acquired difference information.
